(19) United States
(12) Patent Application Publication
(10) Pub. No.: US 2015/0283006 A1
(43) Pub. Date: Oct. 8, 2015

(54) TRANSPORT DEVICES AND METHODS OF USE FOR TRANSPORT OF IMMOBILIZED PERSONS

(71) Applicant: Wilber Akins, Happy Valley, OR (US)

(72) Inventor: Wilber Akins, Happy Valley, OR (US)

(21) Appl. No.: 14/681,494

(22) Filed: Apr. 8, 2015

Related U.S. Application Data
(60) Provisional application No. 61/976,882, filed on Apr. 8, 2014.

(51) Int. Cl. A61G 1/01; A61G 1/048; A61G 5/10; A61G 1/044

(52) U.S. Cl. CPC A61G 1/01; A61G 1/044; A61G 1/048; A61G 5/10

(57) ABSTRACT

Transport devices for transporting immobilized persons including generally planar bodies each having: a body contacting surface for receiving an immobilized person haying a body-supporting main surface, a right arm-supporting surface, and a left arm supporting surface; handles outwardly extended proximal to a perimeter of the body contacting surface, the handles configured to be gripped by one or more users for lifting of the immobilized person; and a body securing mechanism configured to attach the transport device to the immobilized person are shown and described. In some examples, the flexible planar body includes a non-body contacting surface on an opposing surface relative to the body contacting surface. In some further examples, the non-body contacting surface includes attached cross-straps.

### Cross Reference to Related Applications

This application claims priority to and the benefit under 35 U.S.C. § 119(e) of copending U.S. Provisional Patent Application, No. 61/976,882, tiled on Apr. 8, 2014, which is hereby incorporated by reference for all purposes.

### BACKGROUND

The present disclosure relates generally to transport devices and methods of transport for immobilized persons. In particular, transport devices and methods for intermediary transport of immobilized persons from a wheel chair to another desired location are described.

Immobilized persons (e.g., paraplegic, quadriplegic, or otherwise immobilized) often are commonly transported via self-powered or push-type wheel chairs. In some instances, the immobilized persons must access or be moved into a location that is not wheel chair accessible. In these instances, an intermediary form of transport may be employed.

For example, during boarding of an airplane, immobilized persons must be transported onto the airplane and into an airplane seat without the use of their wheel chair. In this example, a standard bedding sheet is commonly used by sliding the sheet under the immobilized person and several airline staff members gripping the sides of the sheet and lifting the immobilized person out of their wheel chair. The airline staff members then carry the immobilized person onto the airplane and transfer the immobilized person into the airplane seat using the bedding sheet. A similar process must be carried out during de-boarding of the airplane. Further, intermediary transport of an immobilized person from a wheel chair may be required in a variety of other situations (e.g., when moving an immobilized person into a hospital bed, into a bath tub, into a chair that is located in an area that is up a set of stairs, etc.).

Known mechanisms and methods for transportation of intermediary transport of immobilized persons are not entirely satisfactory for the range of applications in which they are employed. For example, when using a bedding sheet for intermediary transport of an immobilized person, a gripping surface provided by the bedding sheet can be awkward to hold and easily slip from the hands of a person gripping the sheet. In this example, there is a danger that the immobilized person may be dropped and injured. Moreover, the airline, business, and/or person transporting the immobilized person may be injured themselves and/or be liable for injury of the immobilized person if such injury occurs because of improper handling. In another example, a sheet may not have sufficient weight capacity to support the weight of an immobilized person's body. In this example, the sheet may rip and/or tear and again the immobilized person may be dropped and at risk of injury.

Furthermore, know mechanisms and methods for intermediary transport of immobilized persons may be uncomfortable and awkward for the immobilized person. For example, a bedding sheet is not specifically designed to accommodate a lifted body. As such, the body of an immobilized person may slide into a central area of the sheet and force the body into a wedged, uncomfortable, and/or dangerous position. As in the examples above, the immobilize person may be at risk of injury from being forced into the awkward position and being unable to move themselves out of the awkward position.

Thus, there exists a need for devices and methods of intermediary transport of immobilized persons that improve upon and advance the design of known methods and devices. Examples of new and useful methods and devices for intermediary transport of immobilized person and relevant to the needs existing in the field are discussed below.

### SUMMARY

The present disclosure is directed to transport devices for transporting immobilized persons. Each of the transport devices are a generally flexible planar body having: a body contacting surface configured to receive a body of the immobilized person with a body-supporting main surface, a left arm-supporting surface, and a right arm-supporting surface; handles disposed proximal to a perimeter of the body contacting surface and outwardly extended from the body contacting surface, the plurality of handles configured to be gripped by one or more users for lifting of the immobilized person; and a body securing mechanism configured to attach the transport device to the body of the immobilized person. In some examples, the flexible planar body includes a non-body contacting surface on an opposing surface of the transport device relative to the body contacting surface. In some further examples, the non-body contacting surface includes attached cross-straps, the attached cross-straps having both lateral straps and longitudinal straps.

### BRIEF DESCRIPTION OF THE DRAWINGS

FIG. 1 is a top perspective view of a first example of a transport device in a chair-fitted position.

FIG. 2 is a side perspective view of the first example transport device shown in FIG. in the chair-fitted position.

FIG. 3 is a top plan view of the first example transport device shown in FIG. 1 in an out-stretched position.

FIG. 4 is a bottom plan view of the first example transport device shown in FIG. 1 in the out-stretched position.

FIG. 5 is a top plan view of the first example transport device shown in FIG. 1 in a folded storage position.

FIG. 6 is a front perspective view of the first example of a transport device showing an immobilized person and two users preparing for intermediary transport.

### DETAILED DESCRIPTION

The disclosed devices and methods of intermediary transport of immobilized persons will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, a variety of example devices and methods of intermediary transport of immobilized persons are provided. Related features in the examples may be identical, similar, or dissimilar in different examples. For the sake of brevity, related features will riot be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

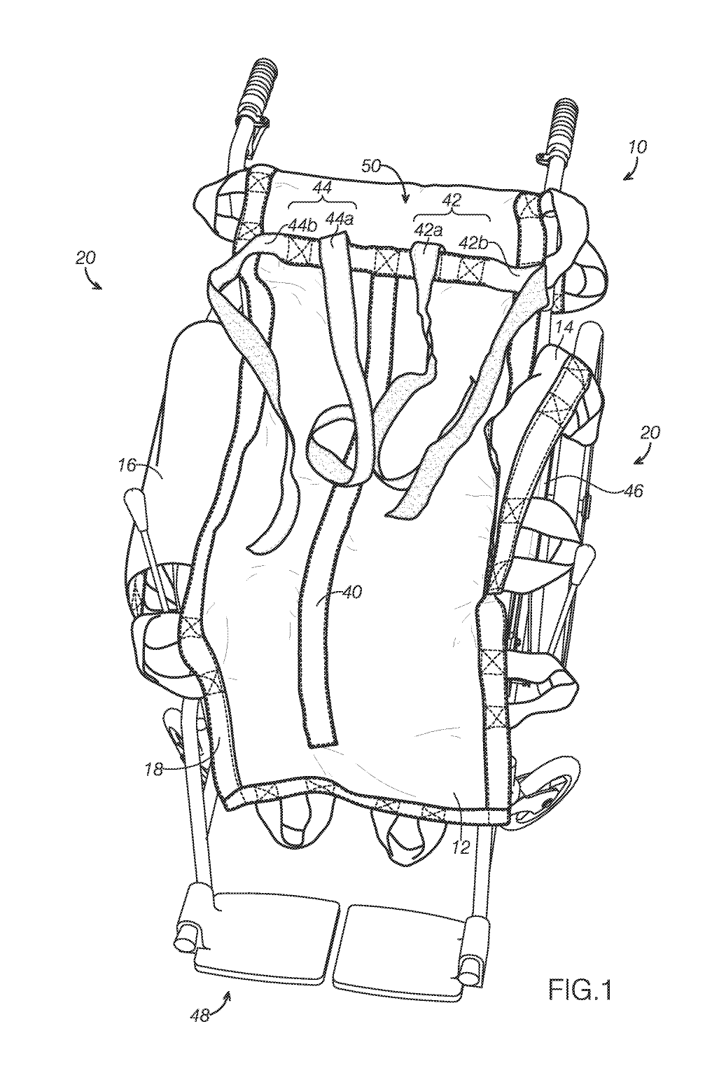

With reference to FIGS. 1-6 a first example of an intermediary transport device, transport device 10, will now be described. Transport device 10 has a substantially flexible planar body that functions to provide a more easily operated mechanism for transport of an immobilized person from a chair (e.g., a wheel chair) to another location, such as a location that is not wheel chair accessible (e.g., an airplane, up a set of stairs, into a bed, etc.). Additionally or alternatively, transport device 10 can be used to provide a safer mechanism of transport for the immobilized person and the users assisting in transport.

Transport device 10 addresses many of the shortcomings existing with conventional transport devices for immobilized persons. For example, transport device 10 is fabricated from a flexible material and has a shape that is configured to the specific shape of a chair (e.g., a wheel chair) for alignment with an immobilized person's body seated in the chair prior to transport Transport device 10 includes handles along sides of the transport device, as well as straps for securing the immobilized person's body within the transport device. Further, transport device 10 is configured to support a heavier body weight than conventional transport mechanisms. Furthermore, transport device 10 is easily foldable into a storage position.

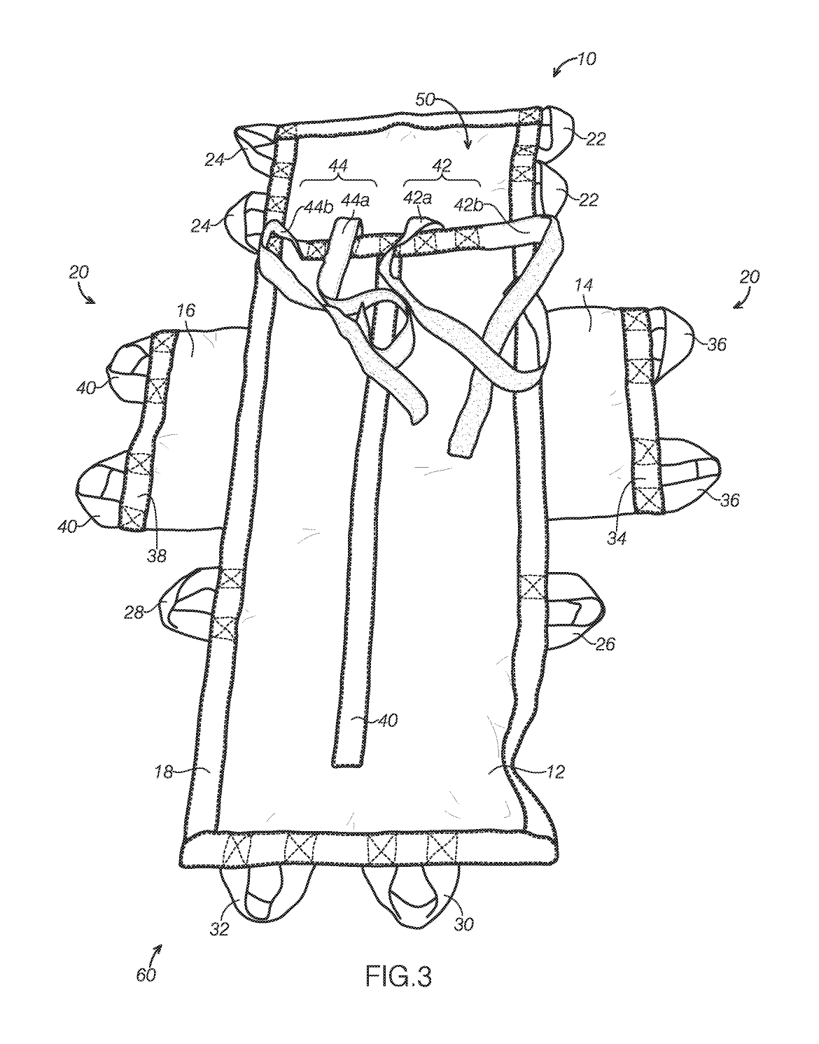

As shown in FIGS. 1 and 3, a body contacting surface 50 of transport device 10 (i.e., of the flexible planar body) includes a body-supporting main surface 12, a left arm-supporting surface 14, and a right arm-supporting surface 16. Body-supporting main surface 12 includes a perimeter strap 18 with a plurality of handle straps 20 extended outwardly from the perimeter strap.

In the present example, plurality of handle straps 20 includes a pair of left side head-supporting handles 22, a pair of right side head-supporting handles 24, left side leg-supporting handle 26, right side leg-supporting handle 28, left side foot-supporting handle 30, and right side foot-supporting handle 32. It will be appreciated that in other examples, plurality of handle straps 20 can include more or fewer handles. In one specific alternate example, the plurality of handle straps can include a tight side head-supporting handle and a left side-head supporting handle extended outwardly from the perimeter strap.

Plurality of handle straps 20 further includes a pair of left side arm-supporting handles 36 and a pair of right side arm-supporting handles 40. Pair of left side arm-supporting handles 36 are extended beyond an edge strap 34 of left arm-supporting surface 14. Similarly, pair of right side arm-supporting handles are extended beyond an edge strap 38 of right arm-supporting surface 16. It will be appreciated that in other examples, the transport device can include more or fewer handles on the arm-supporting surfaces.

In the example of FIGS. 1 and 3, body contacting surface 50 further includes a central support strap 40, a left side shoulder strap 42, and a right side shoulder strap 44. Shoulder straps 42 and 44 are configured to fit around and retain shoulders and/or a chest of an immobilized person. Accordingly, each of the shoulder straps may be complimentarily configured to he attachable and/or tightenable.

In the present example, each of shoulder straps 42 and 44 includes a pair of strap arms (i.e., 42a and 42b, 44a and 44b, respectively) having a looped material on a first strap arm and a hook material on a second strap arm (e.g., Velcro). The strap arms can be attached to each other so that the straps are quickly and easily secured and tightened to an appropriate degree around the shoulders and chest of an immobilized person. Further, the straps can be easily unattached and the immobilized person released.

In alternate examples, the shoulder straps may have a different mechanism of attaching (i.e., engaging) and/or tightening. In one alternate example, the first strap arm may include a double-D ring buckle that the second strap arm is threaded through for attachment and tightening around the shoulders and chest of an immobilized person. In another alternate example, each shoulder strap can be a closed loop where an arm of the immobilized person is threaded through the closed loop. In this example, each closed loop can include a matable partner for connecting the shoulder straps at the chest of the immobilized person. In some examples, one or more of the matable partners can include a mechanism for tightening the closed loops.

It will be appreciated that the transport device can include additional straps for securing the body of the immobilized person to the transport device (e.g., head securing strap, torso securing straps, arm securing straps, leg securing straps, etc.). It will be further appreciated that the above described securing straps are substantially a body securing mechanism, and the transport device can alternatively or additionally include any other body securing mechanism known or yet to be discovered.

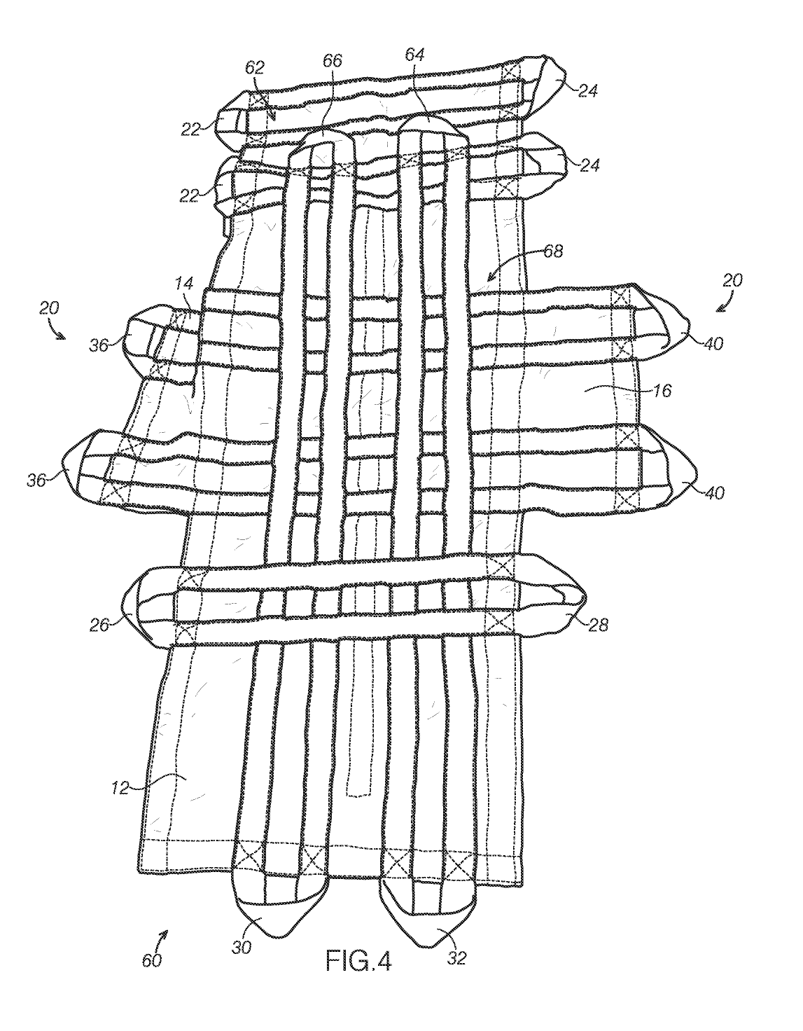

Turning now to a non-body contacting surface 62 that is an opposing surface of transport device 10 (i.e., the flexible planar body) relative to body-contacting surface 50 is shown. Surface 62 includes two additional handles of handle straps 20, a right side head-supporting handle 64 and a left side head-supporting handle 66, disposed proximal to a location where the heat of an immobilized person contacts the body contacting surface during use. Also depicted in FIG. 4, non-body contacting surface 62 further includes a plurality of cross-straps 68. As evident in FIG. 4, each of the handles 20 is created by sewing a long strap across surface 62 that is looped at opposing ends. In other words, each of the handles is formed by an end loop of the cross-straps. The series of cross-straps are configured to provide structure (e.g., a grid) to support the weight of the immobilized person during transport. In alternate examples, the cross-straps can be arranged in a different configuration (e.g., diagonally). In other alternate examples, the plurality of handles may be sewn directly to the perimeter straps and/or edge straps, and the cross straps may be eliminated.

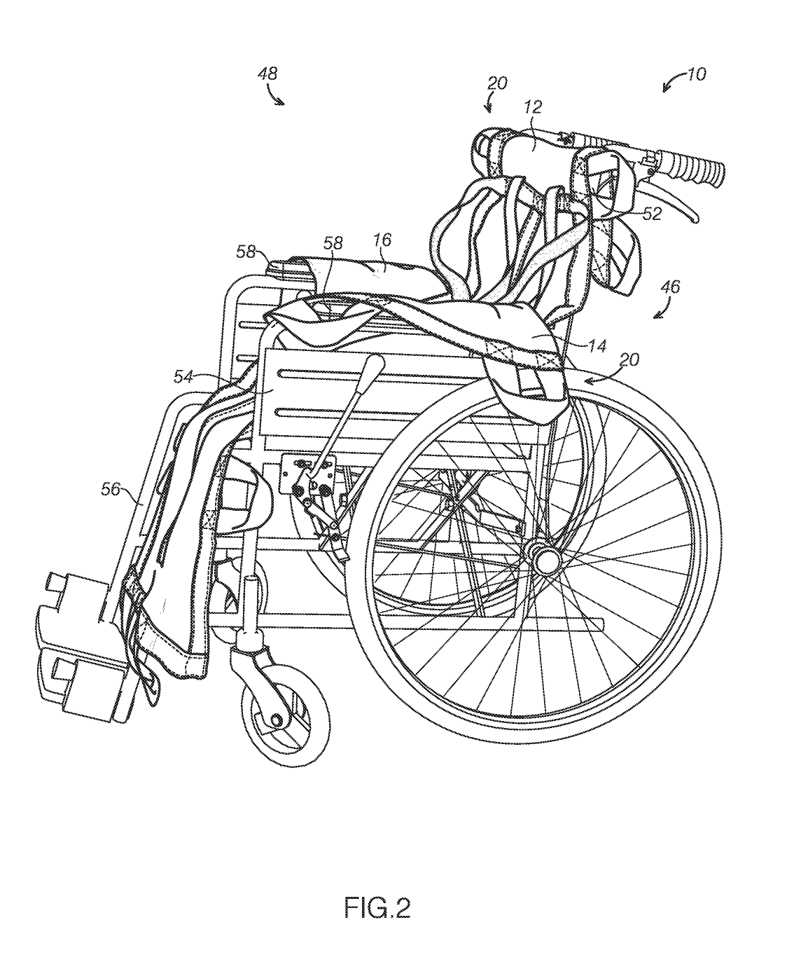

Returning to FIGS. 1 and 2, in one example position, transport device 10 is shown over-laid in a wheel chair 46 in a chair-fitted position 48. In chair fitted position 48, body-supporting main surface 12 is extended over a back support 52, a seat 54, and a leg region 56 of chair 46. Further, the arm supporting surfaces 14 and 16 extend over arms 58 of chair 46. In this example, transport device 10 can be located beneath an immobilized person sitting in either of a chair or a wheel chair.

In a second example position, FIGS. 3 and 4 show transport device 10 in an outstretched position 60. During intermediary transport of an immobilized person (i.e., when the transport device and the immobilized person are lifted from the chair), transport device 10 is generally in the outstretched position 60. Further, if an immobilized person is being moved into a laid out position (e.g., being moved into a bed), transport device 10 can remain in out-stretched position 60 even after transport/lifting is complete.

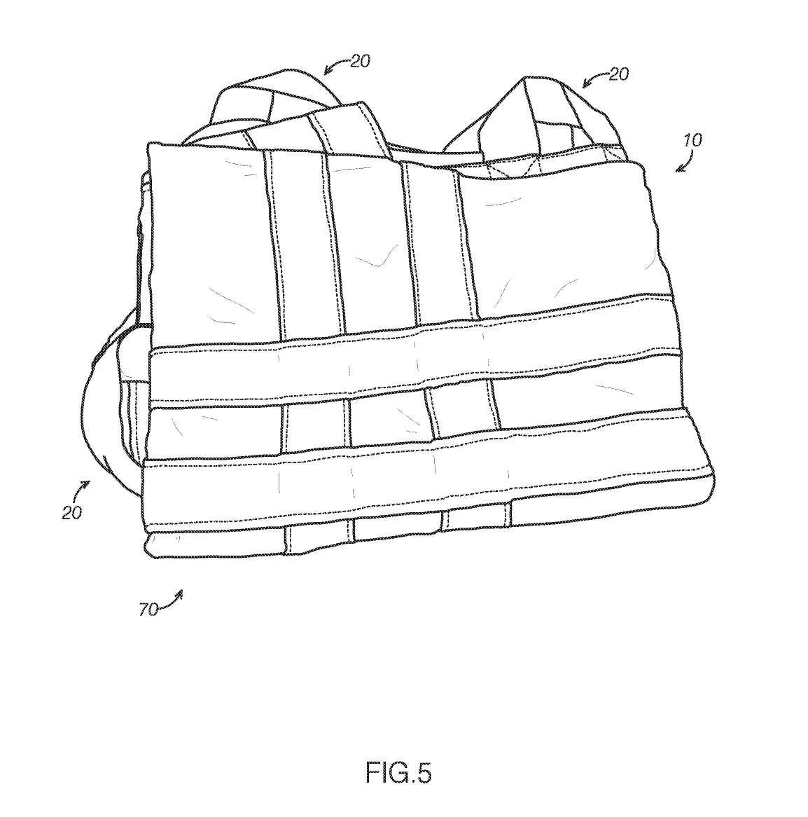

In a third example position, FIG. 5 shows transport device 10 in a folded storage position 70. In folded storage position 70, transport device 10 is folded so that it can easily be inserted into a storage bag (not specifically shown) when it is not in use. Alternatively, a releasably attachable strap (e.g., a Velcro strap, a buckle strap, etc.) can be engaged and tightened around the folded transport device so that the transport device can be carried by any of the plurality of handles 20 that are extended outwardly from the transport device in the folded storage position. In some examples, the shoulder straps can be configured to additionally function in binding the transport device into the folded storage position.

For operation, transport device 10 is first positioned under an immobilized person in a chair, a wheel chair, or a bed. This can be accomplished by the immobilized person being partially lifted and sliding the transport device under the immobilized person. If the immobilized person is in a chair or a wheel chair, the transport device is then in the chair-fitted position. Alternatively, if the immobilized person is initially in a bed, the transport device is in the out-stretched position.

The shoulder straps are then secured and/or tightened around the shoulders and chest of the immobilized person. In examples including additional securing straps, any straps may be secured that specifically secure the body of the immobilized person in a safe position.

Next, two or more operators (as required by the weight and size of the immobilized person) each grip two of the handles that best support the body of the immobilized person and the person is lifted from the chair, wheel chair, or bed by the operators. The transport device then generally extends towards the out-stretched position (e.g., the transport device in an intermediate position between the chair-fitted position and the out-stretched position) as the person is carried.

The operators then set the immobilized person in the desired position. For example, the immobilized person can be transported to a chair, a wheel chair, or a bed that are in a non-wheel chair accessible location. The shoulder straps (and any other securing straps) can then be released, and the immobilized person can be partially lifted to remove the transport device. Alternatively, the transport device can remain positioned under the immobilized person for subsequent intermediary transport operations (e.g., return of the immobilized person to a wheel chair).

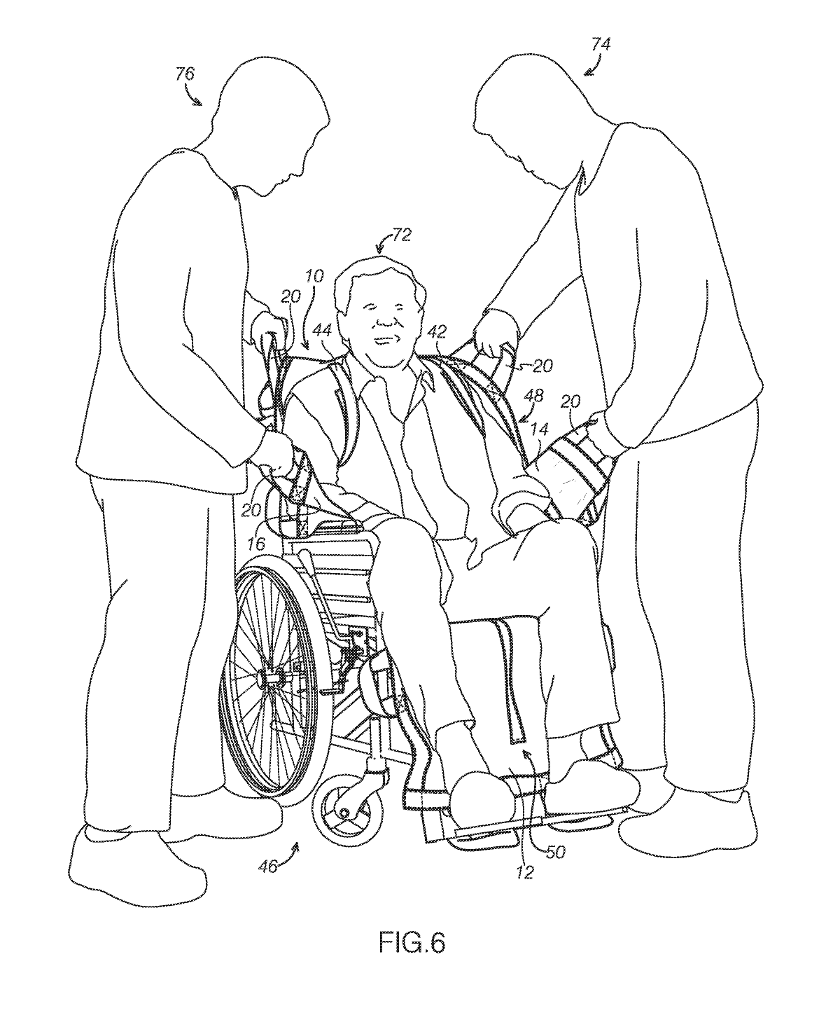

FIG. 6 shows an example view of an immobilized person 72 in wheel chair 46. Transport device 10 is positioned between person 72 and wheel chair 46. Specifically, body-supporting main surface 12 is positioned under the torso and legs of person 72, while arm-supporting surfaces 14 and 16 are positioned under the left arm and the right arm, respectively, of person 72. Further, shoulder straps 42 and 44 are fitted and tightened around the left shoulder and the right shoulder, respectively, of person 72.

Handles 20 extend outwardly from body supporting surface 50. As depicted in FIG. 6, assisting Persons 74 and 76 are each gripping two of handles 20 on a left side and a ride side, respectively, of immobilized person 72. Persons 74 and 76 can then lift upwards on handles 20 to lift person 72 out of wheel chair 46 to another location. In the example of FIG. 6, the assisting persons are each gripping one head supporting handle and one aria supporting handle. It will be appreciated that, in alternate examples, the assisting persons can grip different handles for lifting and intermediary transport of the immobilized person. Further, in other alternate examples, additional assisting persons can grip others of handles 20 for lifting and intermediary transport of person 72.

It will be appreciated that the transport device can be manufactured in different sizes specific to the size of a body of an immobilized person. For example, a transport device can be manufactured with smaller dimensions for use a woman, and a transport device can be manufactured with larger dimensions for use by a man.

In the present example, the straps and the handles are comprised of a thicker woven material, such as such as nylon, polyester, and/or cotton strapping material. Further, the body-supporting main surface and the arm-supporting surfaces are comprised of thinner woven material, such as canvas, nylon, polyester, or a combination of materials. It will be appreciated that the transport device can be comprised of any flexible and sturdy materials known or yet to be discovered that are suitable for hearing the weight of an immobilized person.

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes novel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should he understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

1. A transport device for transporting an immobilized person, the transport device being generally planar and flexible body comprising:
a body contacting surface configured to receive a body of the immobilized person, the body contacting surface having:
a body-supporting main surface,
a left arm-supporting surface, and
a right aria supporting surface;
a plurality of handles disposed proximal to a perimeter of the body contacting surface and outwardly extended from the body contacting surface, the plurality of handles configured to be gripped by one or more users for lifting of the immobilized person; and
a body securing mechanism configured to attach the transport device to the, body of the immobilized person.

2. The transport device of claim 1, further comprising a perimeter strap attached to a perimeter of the body-supporting main surface,
wherein the left arm-supporting surface, the right arm-supporting surface, and one or more of the plurality of handles are attached to the perimeter strap.

3. The transport device of claim 1, further comprising a first edge strap attached to an outer edge of the left arm-supporting surface, one or more of the plurality of handles being attached to the first edge strap, and
a second edge strap attached to an outer edge of the right arm-supporting surface, one or more of the plurality of handles being attached to the second edge strap.

4. The transport device of claim 1 wherein the body securing mechanism comprises a pair of shoulder straps.

5. The transport device of claim 4, wherein each of the pair of shoulder straps comprises a first strap arm and a second strap arm that are selectively matable and tightenable around shoulders of the immobilized person.

6. The transport device of claim 1, further comprising a non-body contacting surface on an opposing surface of the transport device relative to the body contacting surface.

7. The transport device of claim 6, wherein the non-body contacting surface has a plurality of attached cross-straps, the plurality of attached cross-straps being a plurality of lateral straps and a plurality of longitudinal straps.

8. The transport device of claim 7, wherein the plurality of handles comprises a plurality of first longitudinal side handles disposed on a first longitudinal edge of the transport device and a plurality of second longitudinal side handles disposed on a second longitudinal edge of the transport device, each of the plurality of first longitudinal side handles and each of the plurality of second longitudinal side handles being formed by an end loop of the lateral straps that is extended beyond a perimeter of the body contacting surface.

9. The transport device of claim 7, wherein the plurality of handles comprises one or more lateral side handles on bottom lateral edge of the transport device, each of the one or more lateral side handles being formed by an end loop of the longitudinal straps that is extended beyond a perimeter of the body contacting surface.

10. The transport device of claim 6, wherein the non-body contacting surface has one or more head-supporting handles disposed proximal to a location where a head of the immobilized person rests on the body contacting surface during use of the transport device.

11. The transport device of claim 10, wherein the non-body contacting surface has a plurality of attached cross-straps, the plurality of attached cross straps being a plurality of lateral straps and a plurality of longitudinal straps, each of the one or more head-supporting handles being formed by an end loop of the longitudinal straps.

12. The transport device of claim 1, wherein the transport device is moveable between a chair-fitted position and an outstretched position, and
wherein, in the chair-fitted position, the left arm-supporting surface overlays a left arm of a chair, the right arm-supporting surface overlays a right arm of the chair, and the body-supporting main surface overlays a back support and a seat of the chair.

13. A transport device for transporting an immobilized person, the transport device being flexible and comprising:
a flexible planar body having:
a body contacting surface configured to receive a body of the immobilized person; and
a non-body contacting surface on an opposing surface of the flexible planar body relative to the body contacting surface;
a plurality of handles disposed proximal to a perimeter of the flexible planar body and outwardly extended from the flexible planar body, the plurality of handles configured to be gripped by one or more users for lifting of the immobilized person; and
a plurality of cross-straps attached to the flexible planar body on the non-body contacting surface, the plurality of cross-straps being a plurality of lateral straps and a plurality of longitudinal straps.

14. The transport device of claim 13, wherein the plurality of handles comprises a plurality of first longitudinal side handles disposed on a first longitudinal edge of the flexible planar body and a plurality of second longitudinal side handles disposed on a second longitudinal edge of the flexible planar body, each of the plurality of first side handles and the plurality of second side handles being formed by an end loop of the lateral straps that extends beyond the perimeter of the flexible planar body.

15. The transport device of claim 13, wherein the plurality of handles comprises one or more lateral side handles on a bottom lateral edge of the flexible planar body, each of the one or more lateral side handles being formed by an end loop of the longitudinal straps that is extended beyond the perimeter of the flexible planar body.

16. The transport device of claim 13, wherein the non-body contacting surface has one or more head-supporting handles disposed proximal to a location where a head of the immobilized person rests on the body contacting surface during use of the transport device, each of the one or more head-supporting handles being formed by an end loop of the longitudinal straps.

17. The transport device of claim 13, wherein:
the body contacting surface comprises a body-supporting main surface, a left arm-supporting surface, and a right arm-supporting surface,
the transport device is moveable between a chair-fitted position and an outstretched position, and
in the chair-fitted position, the left arm-supporting surface overlays a left arm of a chair, the right arm-supporting surface overlays a right arm of the chair, and the body-supporting main surface overlays a back and a seat of the chair.

18. The transport device of claim 17, further comprising a perimeter strap attached to a perimeter of the a body-supporting main surface, the left arm supporting surface, the right arm-supporting surface, and one or more of the plurality of handles being attached to the perimeter strap,
a first edge strap attached to an outer edge of the left arm-supporting surface, one or more the plurality of handles being attached to the first edge strap, and
a second edge strap attached to an outer edge of the right arm-supporting surface, one or more of the plurality of handles being attached to the second edge strap.

19. The transport device of claim 13, farther comprising a body securing mechanism configured to attach the transport device to the body of the immobilized person, the body securing mechanism having a pair of shoulder straps that are selectively tightenable around shoulders of the immobilized person.

20. A transport device for transporting an immobilized person, the transport device being flexible and moveable between a chair-fitted position and an outstretched position, the transport device comprising:
a flexible planar body having:
a body contacting surface configured to receive a body of the immobilized person, the body contacting surface having:
a body-supporting main surface,
a left arm-supporting surface, and
a right arm-supporting surface;
a non-body contacting surface on an opposing surface of the flexible planar body relative to the body contacting surface;
a plurality of handles disposed proximal to a perimeter of the flexible planar body and outwardly extended from the flexible planar body, the plurality of handles configured to be gripped by one or more users for lifting of the immobilized person;
a perimeter strap attached to the perimeter of the body-supporting main surface, the left arm-supporting surface, the right arm-supporting surface, and one or more of the plurality of handles being attached to the perimeter strap;
a plurality of cross-straps attached to the flexible planar body on the non-body contacting surface, the plurality of cross-straps being a plurality of lateral straps and a plurality of longitudinal straps, each of the plurality of handles being formed by an end loop of the cross traps that is extended beyond the perimeter of the flexible planar body; and
a body securing mechanism configured to attach the transport device to the body of the immobilized person.
